(19) United States
(12) Patent Application Publication
(10) Pub. No.: US 2026/0339897 A1
(43) Pub. Date: Oct. 29, 2026

(54) QUIESCE FREE FILE SYSTEM SYNCHRONIZATION BY STRETCHING WRITE-AHEAD UPDATES AND REPLAY

(71) Applicant: Nutanix, Inc., San Jose, CA (US)

(72) Inventors: Gautham L, Coimbatore Tamilnadu (IN); Monil Devang Shah, Milpitas, CA (US); Praveen Kumar Padia, Bengaluru, Karnataka (IN)

(21) Appl. No.: 19/275,500

(22) Filed: Jul. 21, 2025

(30) Foreign Application Priority Data
Apr. 29, 2025 (IN) 202541041189

(51) Int. Cl. G06F 16/178; G06F 16/11; G06F 16/16

(52) U.S. Cl. CPC G06F 16/178; G06F 16/128; G06F 16/164

(57) ABSTRACT

A technique synchronizes file systems of a multi-site data replication environment without halting (quiescing) file system operations during data and metadata replication of the file systems. Quiescing of the file system operations may be avoided by extending a file system journal at a primary site of the environment to a secondary site during file system synchronization and replicating the metadata at an inode level. Illustratively, the file system journal is a write-ahead log (WAL) that is configured to ensure atomicity of the file system operations by logging (recording) the operations before updating the metadata to persistent storage. The file system operations recorded on the WAL include namespace operations that change the file system directory structure, e.g., creation and/or deletion of directories and/or files.

### CROSS-REFERENCE TO RELATED APPLICATION

The present application claims the benefit of India Provisional Patent Application Serial No. 202541041189, which was filed on Apr. 29, 2025, by Gautham L, et al. for QUIESCE FREE FILE SYSTEM SYNCHRONIZATION BY STRETCHING WRITE-AHEAD UPDATES AND REPLAY, which is hereby incorporated by reference.

### BACKGROUND

### Technical Field

The present disclosure relates to file system replication and, more specifically, to synchronous replication of data and metadata of file systems from a primary site to a secondary site of a data replication environment.

### Background Information

File system synchronization from a primary file system to a secondary file system typically requires replicating shadow copies or snapshots of the primary file system during which input/output (I/O) accesses are briefly halted (quiesced) while the snapshots occur and at a hand-off or final transfer to the secondary file system. This is especially the case for large file systems having a great number of files, such as a distributed file system. Generally, file system synchronization is a pre-requisite to synchronous replication of file system data and metadata from the primary to secondary file system. However, an issue arises when new data and I/O accesses arrive at the primary file system during the synchronization to the secondary file system. Previous approaches typically quiesce (freeze) application I/O accesses (e.g., reads, writes, create, delete, rename) to the primary file system during the replication, which usually involves traversing a directory structure starting at a root directory and hierarchically walking a namespace of the file system while copying data and metadata. Accordingly, the quiesce duration increases as the number of the files in the file system increases, i.e., I/O access interruption increases in proportion to the number of files in the file system. At some point, the quiesce duration may exceed application thresholds that usually cannot be increased without crashing the applications. Hence the scalability of this approach is limited.

### BRIEF DESCRIPTION OF THE DRAWINGS

The above and further advantages of the embodiments herein may be better understood by referring to the following description in conjunction with the accompanying drawings in which like reference numerals indicate identically or functionally similar elements, of which:

FIG. 1 is a block diagram of a plurality of nodes interconnected as a cluster in a virtualized environment;

FIG. 2 is a block diagram of a virtualization architecture executing on a node to implement the virtualization environment;

FIG. 3 is a diagram illustrating an exemplary input/output (I/O) path of the virtualization architecture;

FIG. 4 is a block diagram of an exemplary multi-site data replication environment configured for use in various deployments such as for backup, content distribution, and/or disaster recovery;

FIG. 5 is a diagram illustrating extension of a file system journal from a primary site to a secondary site of the multi-site data replication environment;

FIG. 6 is a diagram illustrating inode replication in the multi-site data replication environment;

FIG. 7 is a diagram illustrating replay of an inode for a transaction recorded on the file system journal at the secondary site of the multi-site data replication environment; and

FIG. 8 is a flow chart illustrating a transaction replay procedure for the file system journal at the secondary site of the multi-site data replication environment.

### OVERVIEW

The embodiments described herein are directed to a technique configured to synchronize file systems of a multi-site data replication environment without halting (i.e., quiescing) file system operations (e.g., I/O accesses having namespace changes) during data and metadata replication of the file systems. Quiescing of the file system operations is avoided by “extending” (copying) a file system journal at a primary site of the environment to a secondary site during file system synchronization and replicating the metadata at an inode level. Illustratively, the file system journal is a write-ahead log (WAL) that is configured to ensure atomicity of the file system operations by logging (recording) the operations before updating the metadata to persistent storage. The file system operations recorded on the WAL include namespace operations that change the file system directory structure, e.g., creation and/or deletion of directories and/or files. Notably, replication of the file system and WAL may occur concurrently as well as inodes having large amounts of data (exceeding a predefined size) that may employ snapshots to boost replication via concurrent transfers. Further, unlike traditional file system synchronization techniques that traverse block-based metadata representing the file system, the present technique is file-based and traverses inodes (i.e., a map or data structure referencing the inodes) associated with files to implement replication while changes to the namespace may occur, which entails consideration of namespace changes in the file system to ensure complete and correct replication.

During file system synchronization and prior to initiating (starting) inode replication, the WAL at the primary site (primary WAL) is examined for transactions that have not yet completed (active transactions). As used herein, a transaction is an operation that requires atomicity to ensure that an update or change (e.g., to metadata) completes successfully or not at all, e.g., a namespace operation that results in a change to one or more inodes of the file system. The primary WAL is then “extended” (e.g., copied while continuing to receive new I/O accesses at the primary site) to the secondary site to create a synchronization WAL (sync-WAL) and the active transactions are replicated to the sync-WAL at the secondary site. A WAL listener process is instantiated (created) on the primary site to monitor (listen for) logging of new transactions at the primary WAL and replicate those new transactions to the sync-WAL on the secondary site. Accordingly, the sync-WAL is configured to capture (append) new transactions including namespace operations issued upon commencement (start) of inode replication. After the inode replication completes, the new transactions appended to the sync-WAL are replayed to ensure that on-going namespace operations (i.e., operations replicated via the listener) are updated on the secondary file system.

Advantageously, quiesce free file system synchronization of the technique is independent of number of files in a file system (container) and, thus, allows scaling to very large container sizes.

### DESCRIPTION

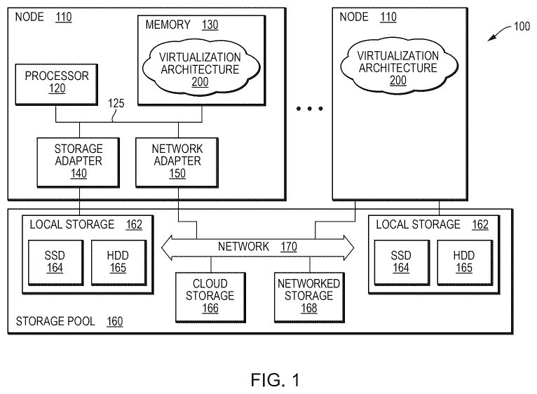

FIG. 1 is a block diagram of a plurality of nodes 110 interconnected as a cluster 100 and configured to provide compute and storage services for information, i.e., data and metadata, stored on storage devices of a virtualization environment. Each node 110 is illustratively embodied as a physical computer having hardware resources, such as one or more processors 120, main memory 130, one or more storage adapters 140, and one or more network adapters 150 coupled by an interconnect, such as a system bus 125. The storage adapter 140 may be configured to access information stored on storage devices, such as solid-state drives (SSDs) 164 and magnetic hard disk drives (HDDs) 165, which are organized as local storage 162 and virtualized within multiple tiers of storage as a unified storage pool 160, referred to as scale-out converged storage (SOCS) accessible cluster wide. To that end, the storage adapter 140 may include input/output (I/O) interface circuitry that couples to the storage devices over an I/O interconnect arrangement, such as a conventional peripheral component interconnect (PCI) or serial ATA (SATA) topology.

The network adapter 150 connects the node 110 to other nodes 110 of the cluster 100 over a network, which is illustratively an Ethernet local area network (LAN) 170. The network adapter 150 may thus be embodied as a network interface card having the mechanical, electrical and signaling circuitry needed to connect the node 110 to the LAN. In an embodiment, one or more intermediate stations (e.g., a network switch, router, or virtual private network gateway) may interconnect the LAN with network segments organized as a wide area network (WAN) to enable communication between the nodes of cluster 100 and remote nodes of a remote cluster over the LAN and WAN (hereinafter “network”) as described further herein. The multiple tiers of SOCS include storage that is accessible through the network, such as cloud storage 166 and/or networked storage 168, as well as the local storage 162 within or directly attached to the node 110 and managed as part of the storage pool 160 of storage items, such as files and/or logical units (LUNs). The cloud and/or networked storage may be embodied as network attached storage (NAS) or storage area network (SAN) and include combinations of storage devices (e.g., SSDs and/or HDDs) from the storage pool 160. Communication over the network may be affected by exchanging discrete frames or packets of data according to protocols, such as the Transmission Control Protocol/Internet Protocol (TCP/IP) and User Datagram Protocol (UDP), as well as protocols for authentication, such as the OpenID Connect (OIDC) protocol, while other protocols for secure transmission, such as the HyperText Transfer Protocol Secure (HTTPS) may also be advantageously employed.

The main memory 130 includes a plurality of memory locations addressable by the processor 120 and/or adapters for storing software code (e.g., processes and/or services) and data structures associated with the embodiments described herein. The processor and adapters may, in turn, include processing elements and/or circuitry configured to execute the software code, such as virtualization software of virtualization architecture 200, and manipulate the data structures. As described herein, the virtualization architecture 200 enables each node 110 to execute (run) one or more virtual machines that write data to the unified storage pool 160 as if they were writing to a SAN. The virtualization environment provided by the virtualization architecture 200 relocates data closer to the virtual machines consuming the data by storing the data locally on the local storage 162 of the cluster 100 (if desired), resulting in higher performance at a lower cost. The virtualization environment can horizontally scale from a few nodes 110 to a large number of nodes, enabling organizations to scale their infrastructure as their needs grow.

It will be apparent to those skilled in the art that other types of processing elements and memory, including various computer-readable media, may be used to store and execute program instructions pertaining to the embodiments described herein. Also, while the embodiments herein are described in terms of software code, processes, and computer (e.g., application) programs stored in memory, alternative embodiments also include the code, processes, and programs being embodied as logic, components, and/or modules consisting of hardware, software, firmware, or combinations thereof.

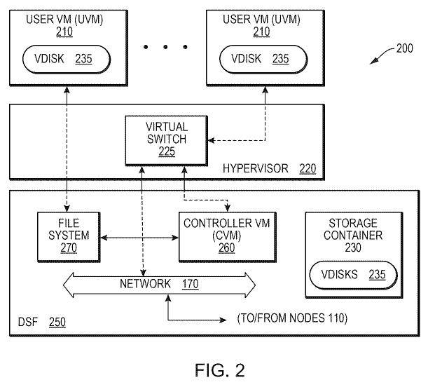

FIG. 2 is a block diagram of a virtualization architecture 200 executing on a node to implement the virtualization environment. Each node 110 of the cluster 100 includes software components that interact and cooperate with the hardware resources to implement virtualization. The software components include a hypervisor 220, which is a virtualization platform configured to mask low-level hardware operations from one or more guest operating systems executing in one or more user virtual machines (UVMs) 210 that run client software. The hypervisor 220 allocates the hardware resources dynamically and transparently to manage interactions between the underlying hardware and the UVMs 210. In an embodiment, the hypervisor 220 is illustratively the Nutanix Acropolis Hypervisor (AHV), although other types of hypervisors, such as the Xen hypervisor, Microsoft's Hyper-V, RedHat's KVM, and/or VMware's ESXi, may be used in accordance with the embodiments described herein.

Another software component running on each node 110 is a special virtual machine, called a controller virtual machine (CVM) 260, which functions as a virtual controller for SOCS. The CVMs 260 on the nodes 110 of the cluster 100 interact and cooperate to form a distributed data processing system that manages all storage resources in the cluster. Illustratively, the CVMs and storage resources that they manage provide an abstraction of a distributed storage fabric (DSF) 250 that scales with the number of nodes 110 in the cluster 100 to provide cluster-wide distributed storage of data and access to the storage resources with data redundancy across the cluster. That is, unlike traditional NAS/SAN solutions that are limited to a small number of fixed controllers, the virtualization architecture 200 continues to scale as more nodes are added with data distributed across the storage resources of the cluster. As such, the cluster operates as a hyper-convergence architecture wherein the nodes provide both storage and computational resources available cluster wide.

A file system 270 is a software component that provides file services to the UVMs 210 including storing, retrieving and processing (executing) data access operations requested by the UVMs 210 and directed to data stored on the DSF 250. The stored data may be represented as a set of storage items, such as files organized in a hierarchical structure of folders (also known as directories), which can contain files and other folders, as well as shares, which can also contain files and folders. Illustratively, the file system 270 may communicate with storage resources provided by CVM 260 to store and retrieve files, folders, shares, or other storage items stored on storage pool 160. The file system 270 may also store and retrieve block-level data, including block-level representations of the storage items, on the storage pool 160.

The client software (e.g., applications) running in the UVMs 210 may access the DSF 250 using filesystem protocols, such as the network file system (NFS) protocol, the server message block (SMB) protocol, the common internet file system (CIFS) protocol, and the internet small computer system interface (iSCSI) protocol. Operations on these filesystem protocols are interposed at the hypervisor 220 and forwarded to the file system 270, which cooperates with the CVM 260 to perform the operations on data stored on local storage 162 of the storage pool 160. The CVM 260 may export one or more iSCSI, CIFS, or NFS targets organized from the storage items in the storage pool 160 of DSF 250 to appear as disks to the UVMs 210. These targets are virtualized, e.g., by software running on the CVMs, and exported as virtual disks (vdisks) 235 to the UVMs 210. In some embodiments, the vdisk is exposed via iSCSI, SMB, CIFS or NFS and is mounted as a virtual disk on the UVM 210. User data (including the guest operating systems) in the UVMs 210 reside on the vdisks 235 and operations on the vdisks are mapped to physical storage devices (SSDs and/or HDDs) located in DSF 250 of the cluster 100.

In an embodiment, the virtual switch 225 may be employed to enable I/O accesses from a UVM 210 to a storage device via a CVM 260 on the same or different node 110. The UVM 210 may issue the I/O accesses as a SCSI protocol request to the storage device. Illustratively, the hypervisor 220 intercepts the SCSI request and converts it to an iSCSI, CIFS, or NFS request as part of its hardware emulation layer. As previously noted, a virtual SCSI disk attached to the UVM 210 may be embodied as either an iSCSI LUN or a file served by an NFS or CIFS server. An iSCSI initiator, SMB/CIFS or NFS client software may be employed to convert the SCSI-formatted UVM request into an appropriate iSCSI, CIFS or NFS formatted request that can be processed by the CVM 300. As used herein, the terms iSCSI, CIFS and NFS may be interchangeably used to refer to an IP-based storage protocol used to communicate between the hypervisor 220 and the CVM 300. This approach obviates the need to individually reconfigure the software executing in the UVMs to directly operate with the IP-based storage protocol as the IP-based storage is transparently provided to the UVM.

For example, the IP-based storage protocol request may designate an IP address of a CVM 260 from which the UVM 210 desires I/O services. The IP-based storage protocol request may be sent from the UVM 210 to the virtual switch 225 within the hypervisor 220 configured to forward the request to a destination for servicing the request. If the request is intended to be processed by the CVM 260 within the same node as the UVM 210, then the IP-based storage protocol request is internally forwarded within the node to the CVM. The CVM 260 is configured and structured to properly interpret and process that request. Notably the IP-based storage protocol request packets may remain in the node 110 when the communication—the request and the response—begins and ends within the hypervisor 220. In other embodiments, the IP-based storage protocol request may be routed by the virtual switch 225 to a CVM 260 on another node of the same or different cluster for processing. Specifically, the IP-based storage protocol request may be forwarded by the virtual switch 225 to an intermediate station (not shown) for transmission over the network (e.g., WAN) to the other node. The virtual switch 225 within the hypervisor 220 on the other node then forwards the request to the CVM 260 on that node for further processing.

Operationally, a UVM 210 may send a data access request (e.g., a read or write operation) to the file system 270 via the hypervisor 220, and the file system 270 may perform the operation specified by the request. The file system 270 may present a virtualized file system to the UVM 210 as a namespace of mappable shared drives or mountable network filesystems of files and directories. The namespace of the virtualized filesystem may be implemented using storage devices of the storage pool 160, onto which the shared drives or network filesystems, files, and folders, or portions thereof, may be distributed as determined by the file system 270. The file system 270 may present the storage capacity of the storage devices as an efficient, highly available, and scalable namespace (directory structure) in which the UVMs 210 may create and access shares, files, and/or folders. As an example, a network share may be presented to a UVM 210 as one or more discrete vdisks 235, but each vdisk may correspond to any part of one or more virtual or physical disks (storage devices) within storage pool 160. The file system 270 may access the storage pool 160 via the CVM 260. The CVM 260 may cooperate with the file system 270 to perform request to the storage pool 160 using local storage 162 within the same node 110, by connecting via the network 170 to cloud storage 166 or networked storage 168, or by connecting via the network 170 to local storage 162 within another node 110 of the cluster (e.g., by connecting to another CVM 260).

In an embodiment, the file system 270 may be represented as a container which, as used herein, is an encapsulation that defines an independent hierarchical file system directory structure (or namespace) that starts at a root directory and branches out (extends) to other user-defined directories and logical entities. In other words, the container provides a namespace having a separate root directory under which users can define their own directory structures with logical entities, e.g., files. An inode is a data structure that is associated with a file (and/or directory) and contains information (metadata) that describes the file, such as a type (e.g., regular or directory) of file, a size of the file, time stamps (e.g., access and/or modification) for the file, and permissions (e.g., to access the file).

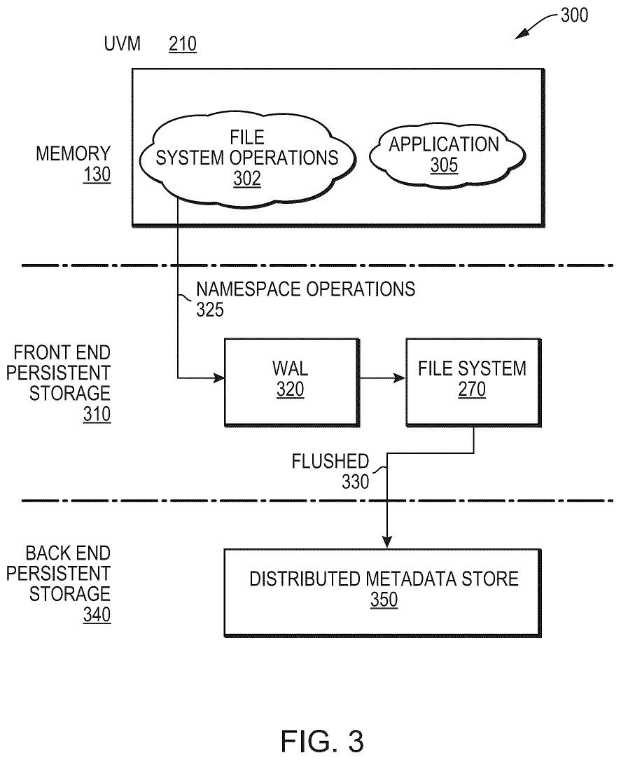

FIG. 3 is a diagram illustrating an exemplary input/output (I/O) path 300 of the virtualization architecture. An application 305 running in UVM 210 of a node 110 issues I/O requests, such as file system operations 302, that are forwarded to file system 270. In an embodiment, the file system (container) is a journaling file system that employs a journal to ensure that the file system operations are atomic. Illustratively, the journal is a write ahead log (WAL 320) configured to ensure atomicity of updates (changes) to metadata (that typically occur in volatile memory 130) by recording (logging) certain file system operations (e.g., I/O accesses including namespace operations 325) on the WAL 320 (e.g., located on front-end persistent storage 310 of SSDs of node 110) before the file system applies the changes to the metadata and then flushes 330 (commits) the metadata updates to a distributed metadata store 350 (e.g., located on back-end persistent storage 340 of SSDs and/or HDDs coupled to node 110). The namespace operations 325 recorded on the WAL 320 are operations that change the file system directory structure, e.g., creation and/or deletion of directories and/or files.

Data replication generally involves copying (replicating) information (e.g., data and metadata) among one or more nodes 110 of clusters 100 embodied as, e.g., datacenters to enable continued operation of data processing operations in a multi-site data replication environment, such as backup, content distribution and disaster recovery. The multi-site data replication environment includes two or more datacenters, i.e., sites, which are typically geographically separated by relatively large distances and connected over a communication network, such as a WAN. For example, data at a local datacenter (primary site) may be replicated over the network to a remote datacenter (secondary site) located at a geographically separated distance to ensure continuity of data processing operations in the event of a failure of the nodes at the primary site.

Synchronous replication may be used to replicate the information between the sites such that each update to the information at the primary site is copied to the secondary site. For instance, every update (e.g., write operation) issued by a UVM 210 to information designated for replication (i.e., replication information) is continuously replicated from the primary site to the secondary site before the write operation is acknowledged to the UVM. Thus, if the primary site fails, the secondary site has an exact (i.e., mirror copy) of the replication information at all times. Synchronous replication generally does not require the use of snapshots of the information; however, to establish a multi-site data replication environment or to facilitate recovery from, e.g., network outages in such an environment, a snapshot may be employed to establish a point-in-time reference from which the sites can (re)synchronize the replication information.

In the absence of continuous synchronous replication between the sites, the current state of the replication information at the secondary site always “lags behind” (is not up to date or synchronized with) that of the primary site resulting in possible information loss in the event of a failure of the primary site. If a specified amount of time lag in synchronization is tolerable (e.g., 60 mins), then asynchronous (e.g., incremental) replication may be selected between the sites, for example, a point-in-time image replication from the primary site to the secondary site is not more than 60 minutes behind. Incremental replication generally involves at least two point-in-time images or snapshots of the information to be replicated, e.g., a base snapshot that is used as a reference and a current snapshot that is used to identify incremental changes to the information since the base snapshot. To facilitate efficient incremental replication in a multi-site data protection environment, a base snapshot is required at each site. Note that the information to be replicated may include an entire state of a file system including file system data and metadata.

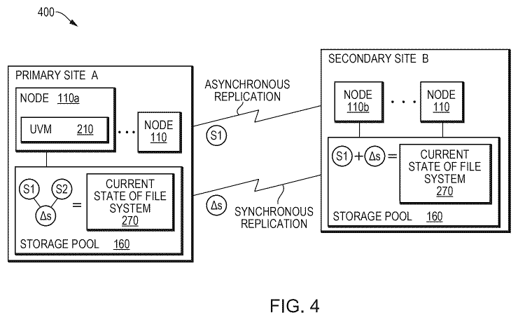

FIG. 4 is a block diagram of an exemplary multi-site data replication environment configured for use in various deployments, such as for backup, content distribution (CD) and/or disaster recovery (DR). Illustratively, the multi-site environment 400 includes two sites: primary site A and secondary site B, wherein each site represents a datacenter embodied as one or more clusters 100 with each cluster having one or more nodes 110. A category of data (e.g., file system data and metadata) running on primary node 110a at primary site A is designated for replication to secondary site B, e.g., secondary node 110b. A first snapshot S1 of the file system may be generated at the primary site A and replicated (e.g., via asynchronous replication) to secondary site B as a base or “common” snapshot S1. A period of time later, a second snapshot S2 may be generated at primary site A to reflect a current state of the file system 270. Since the common snapshot S1 exists at sites A and B, only incremental changes (deltas Δs) to the data designated for failover need be sent (e.g., via synchronous replication) to site B, which applies the deltas (Δs) to S1 so as to synchronize the state of the file system 270 to the time of the snapshot S2 at the primary site.

File system synchronization is a pre-requisite to synchronous replication of file system data and metadata from a primary file system at a primary cluster of nodes (site) to a secondary file system at a secondary site of a multi-site data replication environment. Previous approaches to file system replication involve updates of a secondary file system at a secondary site with content of a primary file system at a primary site prior to synchronous replication commencement to ensure that the primary and secondary file systems are synchronized before enabling synchronous replication.

Synchronization of the primary file system and secondary file systems includes metadata synchronization and data synchronization. Metadata synchronization involves replication of the file system directory structure, e.g., root directory and inodes of files in directories. Metadata synchronization is also a function of the quantity (number) of directories and files in a file system (container), e.g., a relatively small quantity such that replication completes quickly (e.g., seconds). Data synchronization, on the other hand, involves replication of the actual data content of the files, which is a relatively large quantity (e.g., terabytes) and requires a relatively long time (e.g., days) to replicate from a primary site to a secondary site.

A previous approach to metadata synchronization halted (paused) on-going (active) metadata (namespace) operations that mutate (change) the metadata while the metadata is replicated to the secondary site. As used herein, namespace operations are operations that change the file system directory structure, such as creation of directories and/or files, deletion of directories and/or files, rename of directories and/or files, and creation of symbolic links, and the like. The previous approach also halted active data operations (e.g., reads and/or writes to files) as the metadata (namespace) is replicated during metadata synchronization, i.e., until replication of the metadata as a precursor to metadata synchronization completes. Moreover, since the file system operations are a function of the number of files in a file system (container), as the number of files increases the metadata synchronization time increases, which necessitates a restriction or limit to the number of files stored in the container to retain a synchronization period for a recovery point objective (RPO). Thus, if synchronization for more files is needed, additional containers are required which, in turn, may necessitate redistribution among those additional containers as well as other management issues/difficulties. Therefore, use of a single container (e.g., file system namespace) is preferred that can accommodate a larger number of files to obviate scalability limits on the number of files in a single container for synchronization according to a given RPO.

The embodiments described herein are directed to a technique configured to synchronize file systems of a multi-site data replication environment without halting (quiescing) file system operations (e.g., I/O accesses having namespace changes) during data and metadata replication of the file systems. Illustratively, file system operations, such as data and metadata (namespace) operations, may substantially continue, i.e., essentially without pause or quiescence of file system operations (i.e., quiescence free), during metadata synchronization of the file systems. Quiescing of the file system operations may be avoided by extending a file system journal on a node of a primary site (e.g., primary WAL) of the environment to a node of a secondary site during file system synchronization and replicating the metadata at an inode level. Notably, replication of the filesystem and WAL may occur concurrently as well as inodes having large amounts of data (exceeding a predefined size) that may employ snapshots to boost replication via concurrent transfers. Further, unlike traditional file system synchronization techniques that traverse block-based metadata representing the file system, the present technique is file-based and traverses inodes (i.e., a map or data structure referencing the inodes) associated with files to implement replication while changes to the namespace may occur, which entails consideration of namespace changes in the file system to ensure complete and correct replication.

New file system operations (transactions) logged on the primary WAL (e.g., as records) at the primary site are synchronously replicated to the extended WAL (i.e., the synchronization WAL) on the secondary site. Metadata synchronization starts (begins) once the synchronization WAL is established. The primary WAL and synchronization WAL cooperate to keep track of active (on-going) metadata updates (changes) to the primary file system. The metadata updates (records) are replayed (i.e., re-processed) onto the secondary file system after the metadata synchronization (e.g., inode replication) has completed to synchronize the primary and secondary file systems and remediate any inconsistencies that may arise to the file system structure during metadata synchronization. Notably, the primary WAL and synchronization WAL are used in an active-passive mode configuration, wherein the metadata records of the synchronization WAL are always updated from the primary WAL. The synchronization WAL transitions to an active mode in response to a failover where the secondary site becomes the primary site. According to the technique described herein, new file system operations are recorded (logged) onto the synchronization WAL before an atomic update (change) occurs to the inodes (metadata) of the files. The replay procedure on the secondary site creates and inserts those files onto the secondary file system.

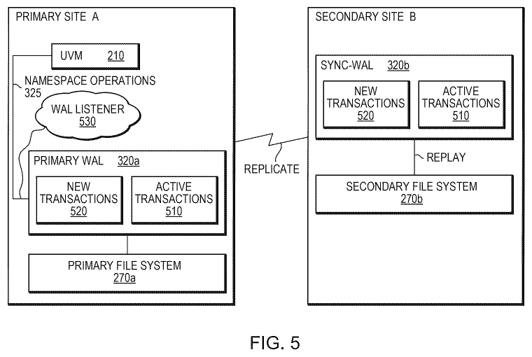

FIG. 5 is a diagram illustrating extension of a file system journal from a primary site to a secondary site of the multi-site data replication environment. Assume file system synchronization is enabled at time, e.g., T1 (not shown). Prior to initiating (starting) inode replication, the file system journal executing on a primary node (e.g., primary node 110a) at primary site A (primary WAL 320a) is examined for transactions that have not yet completed, i.e., active transactions 510 that are in progress. As used herein, a transaction is an operation that requires atomicity to ensure that an update or change (e.g., to metadata) completes successfully or not at all, e.g., a namespace operation 325 that results in a change to one or more inodes of the file system. Active transactions 510 occurring on the primary site A before T1 may not have committed to persistent storage and, thus, the metadata may not be completely updated (e.g., may be in a partially updated state). The active transactions are recorded (logged) in the primary WAL 320a and are flushed to backend persistent storage 340 to commit the transactions.

According to the technique, the primary WAL 320a is “extended” to secondary site B by, e.g., copying (replicating) the primary WAL 320a to a secondary node 110b on the secondary site B while continuing to receive new write I/O/namespace changes (new transactions) at the primary site so as to synchronize the WAL (sync-WAL 320b) and replicate the active transactions 510 to the sync-WAL 320b. New transactions 520 occurring after T1 are synchronously replicated to the secondary site B, persistently stored in the sync-WAL 320b, and acknowledged. In an embodiment, a WAL listener 530 (e.g., software process) is instantiated (created) on the primary site A to monitor (listen for) logging of the new transactions 520 at the primary WAL 320a and replicate those new transactions 520 to the sync-WAL 320b on the secondary site B. Accordingly, the sync-WAL 320b is configured to capture (append) new transactions 520 including namespace operations 325 issued upon commencement (start) of inode replication. After the inode replication completes, the new transactions 520 appended to the sync-WAL 320b are replayed, e.g., onto the secondary file system 270b, to ensure that on-going namespace operations are updated (applied) on the secondary site B.

Unlike previous approaches to metadata (namespace) synchronization that hierarchically traverse the namespace (i.e., walk an inode map) replicating all inodes of files within directories of the namespace and employing snapshots to quiesce changes, the present technique copies the inodes of files while changes are applied by the file system, i.e., as they are mutated, without a need to quiesce those changes via snapshots. As such, changes to the inodes occur as they are accessed (e.g., written/changed) resulting in a namespace that may not be in a consistent state. Accordingly, the sync-WAL is used (leveraged) to record the changes to the inodes while replication progresses to ensure consistency, i.e., the sync-WAL is used to place the secondary file system into a consistent state. Notably, the metadata may reside in any state while replication progresses. As previously indicated, replication of the file system and WAL may occur concurrently as well as inodes having large amounts of data (exceeding a predefined size) that may employ snapshots to boost replication via concurrent transfers.

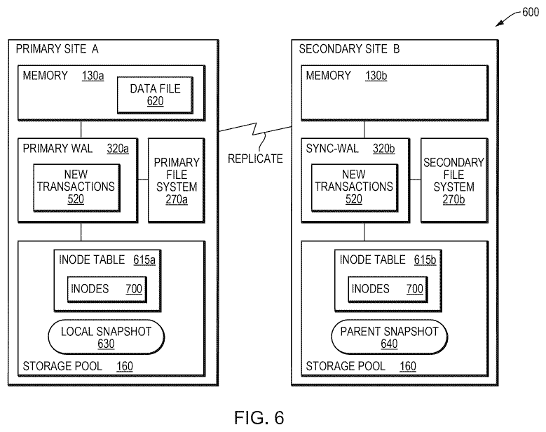

FIG. 6 is a diagram illustrating inode replication in the multi-site data replication environment. In an embodiment, inodes 700 of a file system may be stored on a copy of an inode table 615a that is maintained, e.g., on-disk in storage pool 160 of primary node 110a at primary site A. Inode replication 600 involves scanning and enumerating (identifying) the inodes 700 for replication. For example, to replicate inodes 700 associated with a large data file 620 (e.g., inode referencing a large amount of data exceeding a predetermined size), a local snapshot 630 may be generated from the data file 620 at primary site A. The enumerated inodes 700 of the data file 630 are replicated to, e.g., inode table 615b stored on-disk in storage pool 160 of secondary node 110b at secondary site B and referenced to an empty parent snapshot 640 generated on secondary site B. New file system operations are then configured for synchronous replication. The local snapshot 630 may be replicated (e.g., via a background process concurrent with other replication) to the parent snapshot 640 at the secondary site B. Any new transactions 520 (e.g., updates/changes of inodes 700) are replicated directly to the secondary site B and appended to the sync-WAL 320b. Upon completion of the inode replication 600, the new transactions 520 appended to the sync-WAL 320b may be replayed in batches to the secondary file system 270b. In an embodiment, replication of data files (e.g., local snapshot 630) may occur in batches so as not to interfere with replay of files/data at the sync-WAL, i.e., to avoid locking between transactions of a file that are recorded at the sync-WAL 320b and replay of the transactions. Once data file replication is completely hydrated (filled) to the parent snapshot 640 at the secondary site, the file may be replayed at the sync-WAL, while data of another data file may be filled at the secondary site. Notably, replay of the sync-WAL has no dependency on hydration of the parent snapshot, because the sync-WAL contains metadata, whereas the snapshot contains data which is distinct for the metadata. Thus, in an embodiment, hydration and replay can proceed independently and concurrently.

In an embodiment, each transaction is allocated a unique monotonically increasing integer identifier (ID) and each inode has a field that records the transaction ID of the last transaction that updated the inode, so that transaction IDs of lower value are older. Transaction IDs are illustratively allocated by a transaction engine executing on the primary node (e.g., a NFS leader node) of the primary site. When an inode is updated by a transaction, the transaction ID is recorded (stamped) in the transaction ID field of the inode. The transaction engine writes (logs) the transaction (with ID) as a record to the file system journal. Transaction IDs monotonically increase such that IDs of records in the journal that are less (i.e., lower numeric value) than a current ID of a record may be skipped as “stale” (older) records. The transaction ID field of the inode is checked during replay to determine which records have not yet been updated (having transaction IDs with values higher/newer than that of the inode) and require replay (and which transactions have been updated). For example, the transaction ID is used to determine if the inode requires replay for an incoming transaction recorded in the file system journal (e.g., sync-WAL).

In an embodiment, the transaction IDs are “stretched” (extended) from the primary site to the secondary site. Transaction IDs are illustratively local to the primary site, i.e., the NFS leader node allocates the IDs, which are stamped on inodes during updates. When the inodes are replicated to the secondary site, the transaction IDs are renamed from local IDs to remote IDs and replay of the sync-WAL occurs with respect to the remote transaction IDs. Renaming is significant because the secondary file system may have its own transaction IDs, i.e., transaction IDs that are local to the secondary site. Renaming of the transactions involves maintaining a numeric portion of the ID as allocated by the primary site and changing the name of the field from local (primary) to remote (secondary) for use with the sync-WAL. In this manner, locally applied transactions may be applied or sorted differently than remotely applied transactions, which may have different or independent initial/starting value transaction IDs.

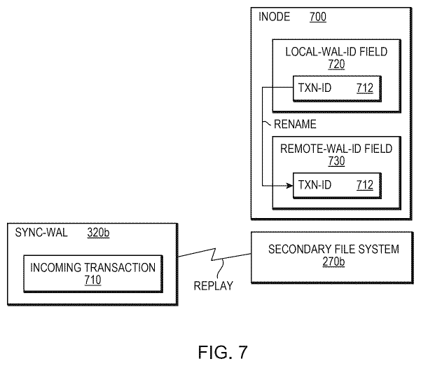

FIG. 7 is a diagram illustrating replay of an inode for a transaction recorded on the file system journal at the secondary site of the multi-site data replication environment. In an embodiment, a transaction ID (TXN-ID) 712 associated with a transaction (e.g., incoming transaction 710) is initially stamped (stored) in a local-WAL-ID field 720 of an inode 700 stored on inode table 615a on primary site A. When the inode 700 is replicated onto the secondary site B, the value of the TXN-ID 712 is moved (renamed) from the local-WAL-ID field 720 to a remote-WAL-ID field 730 of the replicated inode. Replay of the sync-WAL 320b is implemented with reference to the remote-WAL-ID field 730 to determine if replay of the inode 700 to the secondary file system 270b is needed. Incoming transactions 710 to the secondary site B may be appended (e.g., as records) to the sync-WAL 320b as earlier transaction records are replayed. Notably, the rate of transaction replay is illustratively faster than the rate of incoming transactions such that the number (count) of transactions pending in the sync-WAL 320b should constantly diminish (reduce) until the sync-WAL drains completely (i.e., all pending transactions complete).

In an embodiment, the rate of replay (replay rate) of transactions recorded in the sync-WAL 320b is faster than the rate of logging incoming transactions 710 (incoming transaction rate) on the sync-WAL 320b, such that the count of transactions pending replay in the sync-WAL is reduced, i.e., the sync-WAL eventually drains. When the count of pending transactions falls below a predetermined threshold, namespace operations 325 on the primary file system 270a are temporarily paused (inhibited) from being logged on the primary WAL 320a and the pending transactions in the primary WAL 320a are replicated to the sync-WAL 320b as pending transactions. The remaining pending transactions on the sync-WAL 320b are then replayed (re-performed) onto the secondary file system 270b and the sync-WAL 320b is deleted once the replay of the transactions completes. At this point, the namespaces of both primary and secondary file systems are consistent and the technique transitions to “steady state” WAL (synchronous) replication. A “shrinking window,” i.e., where the count of pending transactions falls below the threshold, provides a bounded time period (e.g., less than 1 millisecond) at which namespace operations 325 may be restarted at the primary site A. As noted, namespace replication ensures that the file system namespaces are consistent.

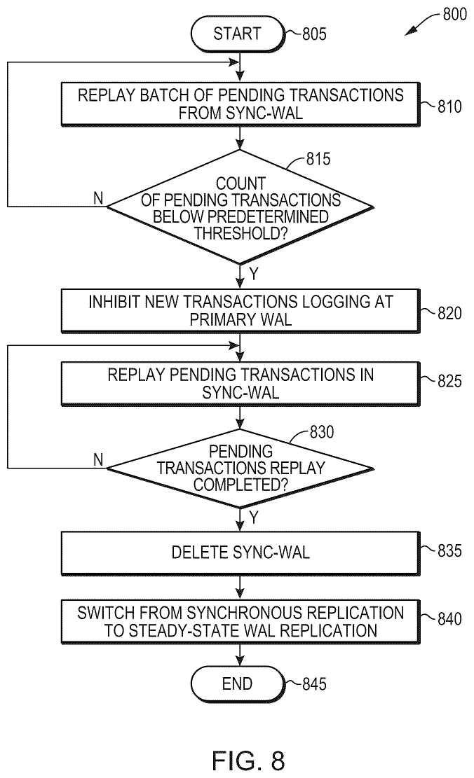

FIG. 8 is a flow chart illustrating a transaction replay procedure for the file system journal at the secondary site of the multi-site data replication environment. The procedure 800 starts at box 805 and proceeds to box 810 where a batch of pending transactions from the file system journal (e.g., sync-WAL) is replayed. At box 815, a determination is rendered as to whether a count (number) of pending transactions is below a predetermined threshold. If not (N), the procedure returns to box 810. Otherwise (Y), new transactions are (temporarily) inhibited (prevented) from recording (logging) at the primary WAL at box 820 and, at box 825, the pending transactions in the sync-WAL are replayed. At box 830, a determination is rendered as to whether the pending transaction replay is completed. If not (N), the procedure returns (iterates) to box 825. Note that use of iterative WAL replays to reduce the pending transaction count to below the threshold reduces the time needed to perform the last WAL replay with namespace operations inhibited. If the pending transaction replay is completed (Y), the sync-WAL is deleted at box 835 and synchronous replication switches (transitions) to steady-state WAL replication at box 840. The procedure then ends at box 845.

At this point, both the primary and secondary file systems are synchronized with respect to namespace and inode-based (small) file data. As indicated previously, large file data (i.e., exceeding a predetermined size) replication may be performed using snapshot replication in a concurrent background process. Depending on the quantity of data, snapshot replication may take a long time (days) to complete. Notably, data replication occurs after namespace replication, which sets up (arranges) the snapshot replication of data for completed files. Illustratively, reads and writes of data to files may only be briefly paused during snapshot generation of the files; otherwise, the reads and writes are not paused during file system data replication. That is, synchronous replication may proceed without quiescing file system operations regardless of the number of files in the file system.

Advantageously, quiesce free namespace synchronization of the technique is directed to replication of a file system hierarchy, i.e., replication of a file system namespace, without halting/freezing namespace operations. To that end, the technique extends the file system journal (WAL) at the primary site to the secondary site. The technique is independent of number of files in a file system (container) and, thus, allows scaling to very large container sizes. A small pause time for snapshotting a large file is constant and remains the same irrespective of the number of files in the container. In addition, extension of an existing WAL at a primary site to operate at a secondary site allows reuse of proven existing transaction replay code to ensure reliability and code simplicity. Extension of the WAL also avoids any new case analysis as the act of replicating inodes underneath the WAL mechanism is akin to capturing the state of the inodes after a crash. Moreover, inode replication by scanning existing inodes (instead of hierarchical path traversal) and WAL replay based on TXN-IDs stamped on the inodes facilitate avoidance of special case handling that, e.g., require additional code for namespace operations, such as renames. Lastly, the technique obviates scalability limits of previous approaches and can accommodate synchronous replication of much larger containers.

The foregoing description has been directed to specific embodiments. It will be apparent however, that other variations and modifications may be made to the described embodiments, with the attainment of some or all of their advantages. For instance, it is expressly contemplated that the components and/or elements described herein can be implemented as software encoded on a tangible (non-transitory) computer-readable medium (e.g., disks and/or electronic memory) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A non-transitory computer readable medium including program instructions for execution on one or more processors, the program instructions configured to:
initiate synchronization of a first file system to a second file system;
traverse an inode data structure referencing each file of the first file system and replicate inodes file-by-file to the second file system while receiving and processing namespace change operations directed to the first file system without quiescing the first file system;
replicate active uncompleted namespace change operations (uncomplete OPs) at the initiation to a log for application to the second file system;
replicate new namespace change operations (new OPs) after the initiation to the second file system for appending to the log;
apply changes to the second file system by replaying the replicated uncomplete OPs from the log to second file system during the data replication; and
apply changes to the second file system by replaying the replicated new OPs from the log to the second file system after replication of each inode completes.

2. The non-transitory computer readable medium of claim 1, wherein the program instructions are further configured to record in each inode of the first file system associated with an applied namespace change operation a monotonically increasing transaction identifier (ID) included in the applied namespace change operation.

3. The non-transitory computer readable medium of claim 2, wherein the program instructions configured to apply changes to the second file system by replaying the replicated new OPs from the log to the second file system are further configured to discard replay of replicated new OPs having transaction ID values less than the transaction ID recorded in the inodes for which the discarded new OPs are sought to be applied.

4. The non-transitory computer readable medium of claim 2, wherein the program instructions are further configured to move the transaction ID of the replicated inodes to another field of the replicated inodes indicating remote transaction ID values and use the remote transaction IDs of inodes to determine discard of new OPs.

5. The non-transitory computer readable medium of claim 1, wherein the program instructions are further configured to create a snapshot for files exceeding a predetermined size and replicate data of the snapshotted file concurrently with replication of the inodes.

6. The non-transitory computer readable medium of claim 1, wherein replication of the inodes is performed in batches, and wherein application of changes to the second file system by replaying the replicated new namespace change operations from the log to the second file system occurs after replication of the batches completes.

7. The non-transitory computer readable medium of claim 1, wherein the program instructions are further configured to in response to a number of pending namespace change operations (pending OPs) for the first file system falling below a predetermined value, temporarily pause processing of new file system operations on the first file system and replicate the pending OPs to the log for application to second file system.

8. The non-transitory computer medium of claim 7, wherein the program instructions are further configured to replay the pending OPs at the second file system and delete the log once replay of the pending OPs is complete.

9. The non-transitory computer readable medium of claim 1, wherein the log is a synchronization write-ahead log (sync-WAL).

10. A method comprising:
initiating synchronization of a first file system to a second file system;
traversing an inode data structure referencing each file of the first file system and replicating inodes file-by-file to the second file system while receiving and processing namespace change operations directed to the first file system without quiescing the first file system;
replicating active uncompleted namespace change operations (uncomplete OPs) at the initiation to a log for application to the second file system;
replicating new namespace change operations (new OPs) after the initiation to the second file system for appending to the log;
applying changes to the second file system by replaying the replicated uncomplete OPs from the log to second file system during the data replication; and
applying changes to the second file system by replaying the replicated new OPs from the log to the second file system after replication of each inode completes.

11. The method of claim 10 further comprising recording in each inode of the first file system associated with an applied namespace change operation a monotonically increasing transaction identifier (ID) included in the applied namespace change operation.

12. The method of claim 11, wherein applying changes to the second file system by replaying the replicated new OPs from the log to the second file system further comprises discarding replay of replicated new OPs having transaction ID values less than the transaction ID recorded in the inodes for which the discarded new OPs are sought to be applied.

13. The method of claim 11 further comprising moving the transaction ID of the replicated inodes to another field of the replicated inodes indicating remote transaction ID values and using the remote transaction IDs of inodes to determine discard of new OPs.

14. The method of claim 10 further comprising creating a snapshot for files exceeding a predetermined size and replicating data of the snapshotted file concurrently with replication of the inodes.

15. The method of claim 10, wherein replication of the inodes is performed in batches, and wherein application of changes to the second file system by replaying the replicated new namespace change operations from the log to the second file system occurs after replication of the batches completes.

16. The method of claim 10 further comprising in response to a number of pending namespace change operations (pending OPs) for the first file system falling below a predetermined value, temporarily pausing processing of new file system operations on the first file system and replicating the pending OPs to the log for application to second file system.

17. The method of claim 16 further comprising replaying the pending OPs at the second file system and deleting the log once replay of the pending OPs is complete.

18. The method of claim 10, wherein the log is a synchronization write-ahead log (sync-WAL).

19. An apparatus comprising:
a network connecting one or more nodes of a first site and a second site, the node having a processor configured to execute program instructions to:
initiate synchronization of a first file system to a second file system;
traverse an inode data structure referencing each file of the first file system and replicate inodes file-by-file to the second file system while receiving and processing namespace change operations directed to the first file system without quiescing the first file system;
replicate active uncompleted namespace change operations (uncomplete OPs) at the initiation to a log for application to the second file system;
replicate new namespace change operations (new OPs) after the initiation to the second file system for appending to the log;
apply changes to the second file system by replaying the replicated uncomplete OPs from the log to second file system during the data replication; and
apply changes to the second file system by replaying the replicated new OPs from the log to the second file system after replication of each inode completes.

20. The apparatus of claim 19, wherein the processor is further configured to execute program instructions to record in each inode of the first file system associated with an applied namespace change operation a monotonically increasing transaction identifier (ID) included in the applied namespace change operation.

21. The apparatus of claim 20, wherein the processor configured to execute program instructions to apply changes to the second file system by replaying the replicated new OPs from the log to the second file system is further configured to execute program instructions to discard replay of replicated new OPs having transaction ID values less than the transaction ID recorded in the inodes for which the discarded new OPs are sought to be applied.

22. The apparatus of claim 20, wherein the processor is further configured to execute program instructions to move the transaction ID of the replicated inodes to another field of the replicated inodes indicating remote transaction ID values and use the remote transaction IDs of inodes to determine discard of new OPs.

23. The apparatus of claim 19, wherein the processor is further configured to execute program instructions to create a snapshot for files exceeding a predetermined size and replicate data of the snapshotted file concurrently with replication of the inodes.

24. The apparatus of claim 19, wherein replication of the inodes is performed in batches, and wherein application of changes to the second file system by replaying the replicated new namespace change operations from the log to the second file system occurs after replication of the batches completes.

25. The apparatus of claim 19, wherein the processor is further configured to execute program instructions to, in response to a number of pending namespace change operations (pending OPs) for the first file system falling below a predetermined value, temporarily pause processing of new file system operations on the first file system and replicate the pending OPs to the log for application to second file system.

26. The apparatus of claim 25, wherein the processor is further configured to execute program instructions to replay the pending OPs at the second file system and delete the log once replay of the pending OPs is complete.

27. The apparatus of claim 19, wherein the log is a synchronization write-ahead log (sync-WAL).
